(19) United States
(12) Patent Application Publication
(10) Pub. No.: US 2014/0229193 A1
(43) Pub. Date: Aug. 14, 2014

(54) System and Process for Optimal Payment Rate Calculation for Diagnostic CPT Code Reimbursement

(71) Applicant: CDL Nuclear Technologies, Inc., Wexford, PA (US)

(72) Inventor: Lon Patrick Wilson, Irwin, PA (US)

(21) Appl. No.: 14/178,899

(22) Filed: Feb. 12, 2014

Related U.S. Application Data
(60) Provisional application No. 61/763,851, filed on Feb. 12, 2013.

(51) Int. Cl. G06Q 50/22; G06Q 30/02

(52) U.S. Cl. CPC G06Q 50/22; G06Q 30/0283
USPC 705/2

(57) ABSTRACT

A process and system for an optimal payment rate calculation of medical diagnostic equipment includes receiving in a processor audit information for each facility using medical diagnostic equipment that includes equipment information that comprises at least a manufactured date of each medical diagnostic device. The system then process further including storing the equipment information in a database and calculating a percentage loss in allowed reimbursement based upon an actual useful life calculation in the processor.

### CROSS-REFERENCE TO RELATED APPLICATIONS

This application claims the benefit from U.S. Provisional Application No. 61/763,851 filed on Feb. 12, 2013, which is hereby incorporated by reference in its entirety for all purposes as if fully set forth herein.

### FIELD OF THE INVENTION

The invention relates to a system and process for tracking medical diagnostic “expensive” equipment and recalculating the reimbursement formula to allow for the input of a mathematical computer computation of the correct payment, based on the useful life of medical diagnostic “expensive” equipment. The invention also relates to a system and process for tracking medical diagnostic “expensive” equipment and recalculating the centers for Medicare and Medicaid Services (CMS) reimbursement formula, which is the standard for Current Procedural Terminology (CPT) code reimbursement to hospitals and physicians, to allow for the input of a mathematical computer computation of the correct payment, based on the useful life of medical diagnostic “expensive” equipment.

### BACKGROUND OF THE INVENTION

Medical providers are allowed to charge for the use of expensive medical diagnostic equipment on, for example, a per minute or fixed annual usage basis. However, currently Medicare and Medicaid Services (CMS) provides for no true input of “useful life” and assumes every 5 years providers purchase new equipment equal to the Practice Expense Advisory Committee (PEAC) input. FIG. 4 shows the CMS reimbursement formula 400 on a per minute basis; and FIG. 5 shows the Medicare fixed costs computation 500 of annual amortized fixed costs for imaging equipment. The equipment cost input is from the American Medical Association PEAC (Practice Expense Advisory Committee to CMS input). A cost input for medical “expensive” diagnostic equipment from the PEAC is used in the CMS reimbursement formula for each diagnostic imaging CPT. Neither one of these formulas take into account the actual age of the equipment.

However, many providers continue to utilize medical “expensive” diagnostic equipment far beyond the 5 year CMS mandated formula. This results in medical providers utilizing older expensive diagnostic equipment and receiving 100% payment. This discourages medical providers from seeking and obtaining the latest and most advanced equipment. Currently, there is no process or system to track the age of the expensive diagnostic equipment and correct payment based on equipment age.

Accordingly, a process and system to track the age of medical diagnostic expensive equipment and correct payment based on the useful life of medical diagnostic “expensive” equipment is needed.

### SUMMARY OF THE INVENTION

The foregoing needs are met, to a great extent, by the invention, wherein in one aspect a technique and apparatus are provided for a mathematical computer computation of a correct payment based on the useful life of medical diagnostic “expensive” equipment.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In one aspect, a process for an optimal payment rate calculation of medical diagnostic equipment includes receiving in a processor audit information for each facility using medical diagnostic equipment that includes equipment information that comprises at least a manufactured date of each medical diagnostic device, storing the equipment information in a database, and calculating a percentage loss in allowed reimbursement based upon an actual useful life calculation in the processor.

The receiving may include receiving over a network. The receiving may include receiving from an information capturing device. A percentage loss may be zero during the useful life of the medical diagnostic device. A percentage loss may be greater than zero after the useful life of the medical diagnostic device. The calculating a percentage loss may include calculating a percentage loss that discretely increases after the useful life of the medical diagnostic device. The calculating a percentage loss may include calculating a percentage loss that continuously increases after the useful life of the medical diagnostic device.

In another aspect, a system for an optimal payment rate calculation of medical diagnostic equipment includes a processor configured to receive audit information for each facility using medical diagnostic equipment that includes equipment information that comprises at least a manufactured date of each medical diagnostic device, a database configured to store the equipment information, and the processor further configured to calculate a percentage loss in allowed reimbursement based upon an actual useful life calculation.

The processor may be further configured to receive information over a network. The processor may be further configured to receive information from an information capturing device. A percentage loss may be zero during the useful life of the medical diagnostic device. A percentage loss may be greater than zero after the useful life of the medical diagnostic device. The calculating a percentage loss may include calculating a percentage loss that discretely increases after the useful life of the medical diagnostic device. The calculating a percentage loss may include calculating a percentage loss that continuously increases after the useful life of the medical diagnostic device.

In yet another aspect, a system for an optimal payment rate calculation of medical diagnostic equipment includes means for receiving audit information for each facility using medical diagnostic equipment that includes equipment information that comprises at least a manufactured date of each medical diagnostic device, means for storing the equipment information, and means for calculating a percentage loss in allowed reimbursement based upon an actual useful life calculation.

The means for receiving may include receiving over a network. The means for receiving may include means for receiving from an information capturing device. A percentage loss may be zero during the useful life of the medical diagnostic device. A percentage loss may be greater than zero after the useful life of the medical diagnostic device. The calculating a percentage loss may include calculating a percentage loss that one of discretely and continuously increases after the useful life of the medical diagnostic device.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1 shows a system for tracking expensive medical diagnostic equipment according to one aspect of the invention.

FIG. 2 shows a process for tracking expensive medical diagnostic equipment according to one aspect of the invention.

FIG. 3 shows a proposed payment methodology according to the invention.

FIG. 4 shows the CMS reimbursement formula on a per minute basis.

FIG. 5 shows the Medicare fixed costs computation of annual amortized fixed costs for imaging equipment.

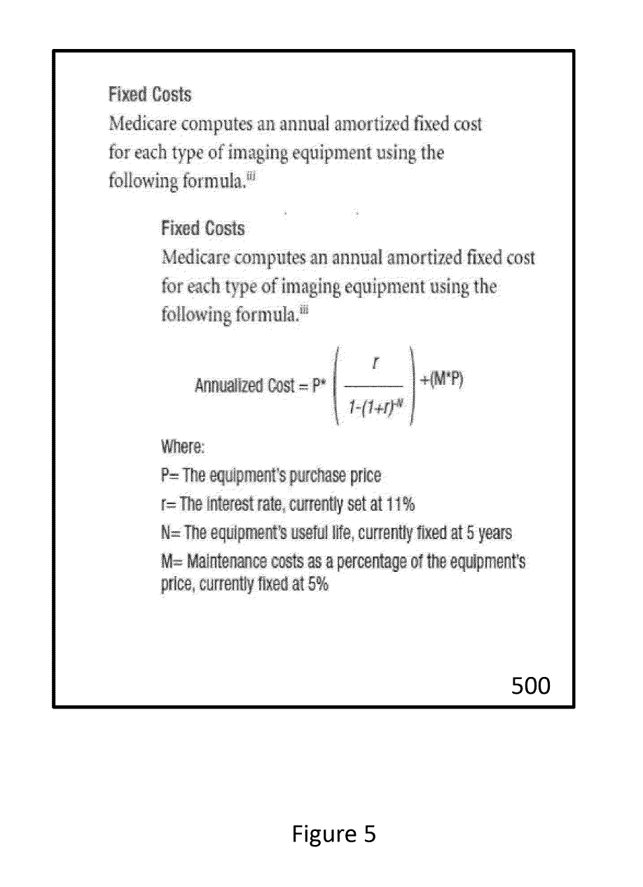

### DETAILED DESCRIPTION

The invention will now be described with reference to the drawing figures, in which like reference numerals refer to like parts throughout. Embodiments of the invention advantageously provide a mathematical computer computation of a correct payment based on the useful life of medical diagnostic “expensive” equipment.

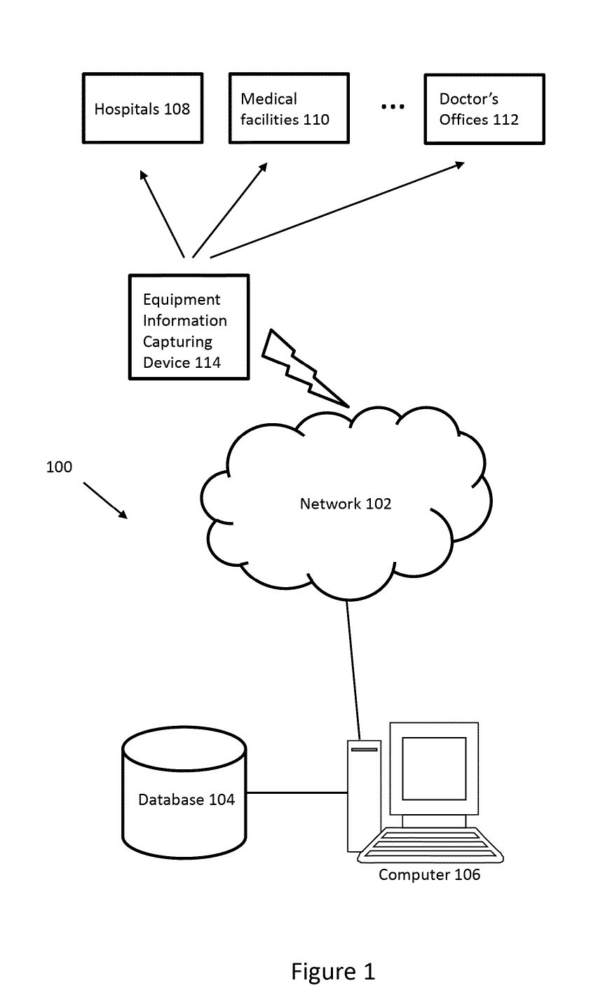

FIG. 1 is directed to a system for tracking expensive medical diagnostic equipment according to one aspect of the invention. As shown in FIG. 1, hospitals 108, medical facilities 110, doctor's offices 112 and the like may utilize expensive medical diagnostic equipment. An equipment information capturing device 114 may be utilized to capture information regarding the expensive medical diagnostic equipment located at hospitals 108, medical facilities 110, doctor's offices 112 and the like. Thereafter, the information captured by the equipment information capturing device 114 may be transmitted to a computer 106 and a database 104. The computer 106 and the database 104 may track the expensive medical diagnostic equipment and recalculate and correct the payment associated with the expensive medical equipment based on the useful life of the medical diagnostic expensive equipment.

The equipment information capturing device 114 may include an output device that may be a display, sound output device, printer, and the like. The equipment information capturing device 114 may include a microprocessor, processor, application specific integrated circuit, and the like (processor) for executing instructions. The processor may execute instructions to capture the data regarding the medical expensive equipment, track the expensive medical diagnostic equipment and recalculate and correct the payment. The equipment information capturing device 114 may include an input device to receive input of information regarding the expensive medical diagnostic equipment. The input device may be a keyboard, touchscreen, barcode reader, scanner, mouse, or the like. For example, the equipment information capturing device 114 may include a printer to print a barcode. The barcode may be subsequently attached to the expensive medical equipment. Thereafter, the input device that includes a scanner may scan the barcode. An operator may then input with a keypad descriptive information relating to the expensive medical equipment such as location, age, type, and the like.

The equipment information capturing device 114 may include a random access memory and a read-only memory to store the information received from the operator regarding the expensive medical equipment. The random access memory may also hold instructions for the operation of the equipment information capturing device 114. The equipment information capturing device 114 may include a transmission device that allows the equipment information capturing device 114 to transmit the information regarding expensive medical equipment over a network 102 to a centralized computer 106 and database 104. The transmission device may include a wireless or wired transmission device including a transceiver that transmits data over a communication channel as defined herein. In one implementation the equipment information capturing device 114 may be a PC, laptop, tablet computer, a smart phone, or the like.

The computer 106 may include an input device such as a keyboard, keypad, touchscreen, mouse and the like. The computer 106 may further include an output device including a display, printer, audio output and the like. The computer 106 may include a random access memory and a read-only memory to store the information received regarding the expensive medical equipment. The random access memory may also hold instructions for the operation of the computer 106. In one implementation, the computer 106 may be a PC, laptop, tablet computer, a server, or the like.

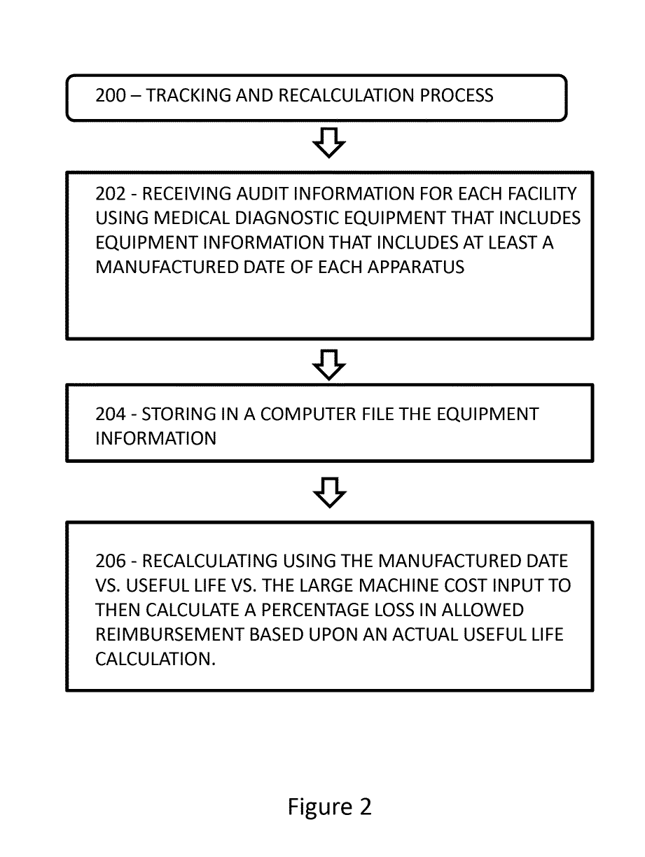

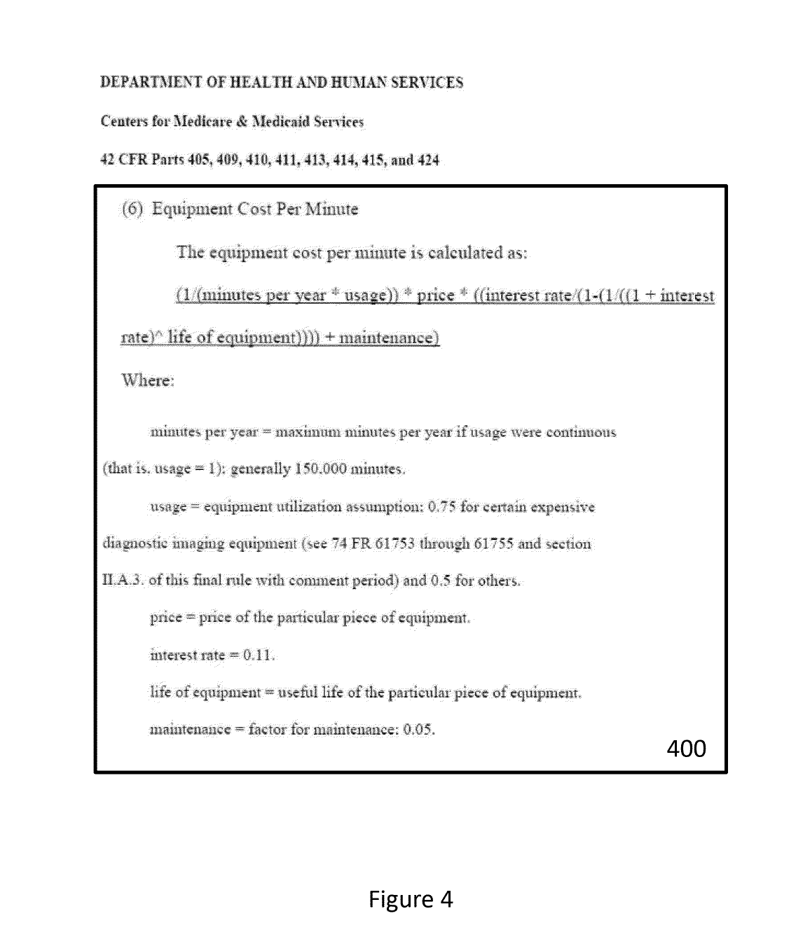

FIG. 2 shows a process for tracking expensive medical diagnostic equipment according to one aspect of the invention. In this regard, the invention may include a process whereby a private payor reimbursement formula is recalculated to then allow for the input of a mathematical computer computation of the correct payment based on the useful life of medical diagnostic “expensive” equipment. Moreover, the invention may include a process whereby the CMS reimbursement formula (FIG. 4), which is the standard for CPT code reimbursements to hospitals and physicians, is recalculated to then allow for the input of a mathematical computer computation of the correct payment based on the useful life of medical diagnostic “expensive” equipment.

As shown in FIG. 2, a process 200 may include a process 202 of performing an audit of each facility using diagnostic medical equipment. The audit includes capturing equipment information including the manufactured date of each apparatus. In particular, the equipment information capturing device 114 may receive information for each facility using medical diagnostic equipment that includes equipment information that includes at least a manufactured date of each apparatus. Thereafter, the equipment information capturing device 114 may transmit that data over the network 102 to the computer 106. Alternatively, the computer 106 may receive information for each facility using medical diagnostic equipment that includes equipment information that includes at least a manufactured date of each apparatus.

Once the computer 106 receives information for each facility using medical diagnostic equipment that includes equipment information that includes at least a manufactured date of each apparatus, the information may be compiled into a computer file, aggregated, sorted, imported and the like and subsequently stored 204 into the database 104.

In process 206 the information is recalculated using the manufactured date vs. useful life vs. the large machine cost input to then calculate a percentage loss in allowed reimbursement based upon an actual useful life calculation. In particular, the information may utilize the CMS payment formula and recalculate using the manufactured date vs. “useful life” vs. the “large machine” cost input (PEAC) to then calculate a percentage loss in allowed reimbursement based upon the actual “useful life” calculation.

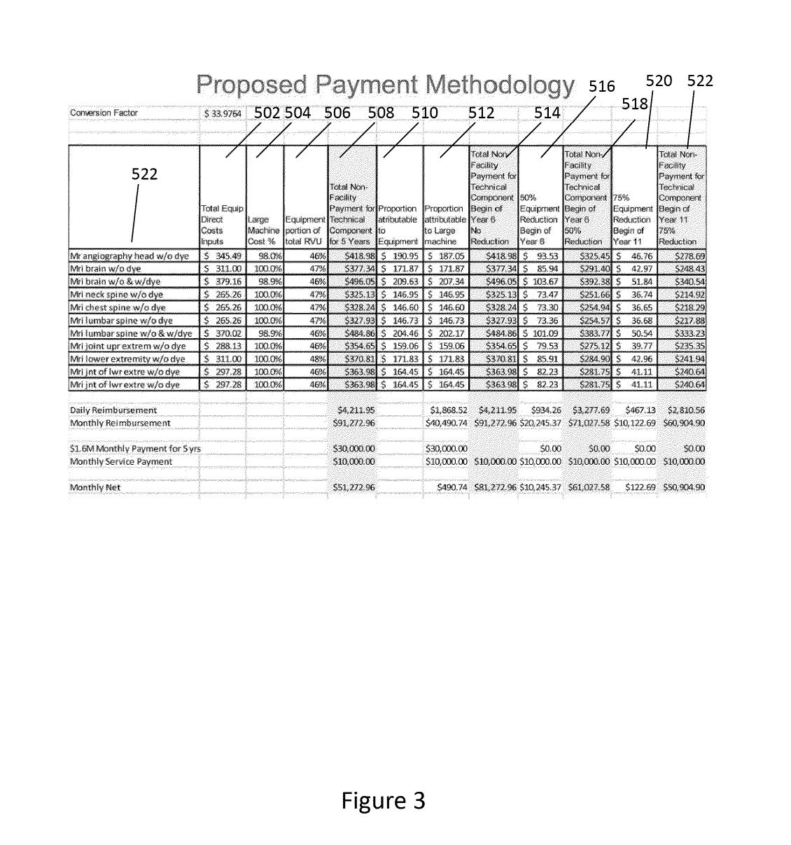

FIG. 3 shows a proposed payment methodology according to the invention. In particular, column 522 shows the various types of equipment that may be utilized in the process of the invention. Other types of equipment are contemplated as well. Column 502 shows exemplary total equipment direct costs for each of the various types of equipment listed in column 522.

Column 504 shows exemplary percentage of the large machine costs for each of the various types of equipment listed in column 522. Column 506 shows the equipment portion of the total relative value units. These values are exemplary and nonlimiting.

Column 508 shows the total non-facility payment for technical components each year for the first 5 years. Again the values are exemplary and nonlimiting. Additionally, column 510 shows the proportion attributable to the equipment; and column 512 shows the proportion attributable to large machine.

As shown in columns 512, 514, and 516 the process is applied as follows. Column 514 is the total non-facility payment for technical components each year beginning year 6 with no reduction. Column 516 shows a 50% equipment reduction beginning year 6. The difference between column 512 and 516 is listed in column 518 which shows the total non-facility payment for technical component each year beginning year 6 with a 50% reduction. Thus, column 518 shows a reduced cost that a facility may seek payment for after year 5 as compared to column 508.

Similarly, column 520 shows a 75% equipment reduction beginning year 11, resulting in the value in column 522 which is the total non-facility payment for technical component each year beginning year 11. Thus, column 522 shows a reduced cost that a facility may seek payment for after year 11 as compared to column 508.

For example, an MRI angiography head without dye would be provided a payment of $418.98 as shown in column 508 during the first 5 years, a payment of $325.45 year 6 to year 11 as shown in column 518, and a payment of $278.69 after year 11 as shown in column 522. The particular years and particular percentage change is merely exemplary. Other percentage rates and time frames for implementation of the changes in percentage rates are contemplated as well. The percentage rates and time frames may be linear or nonlinear, may be discrete, may be continuous, or may be in a predetermined ad hoc manner.

Thus, a process set forth above reduces payments to providers based on the age of the equipment. Savings to the healthcare arena is made possible by correctly paying providers based upon the LHS mathematical formulas and inputs to the CMS mandated formula for “useful life” of expensive large machine costs and the PEAC direct inputs which at this time are not obvious to payors. Currently CMS provides for no true input of “useful life” and assumes every 5 years providers purchase new equipment equal to the PEAC input. Since many providers now continue to utilize medical “expensive” diagnostic equipment far beyond the 5 year CMS mandated formula, LHS computes and derives the algorithm to recalculate the inputs to derive payment adjustments to import useful and readjusted cost data into the payment programs used by insurers to reimburse providers.

The invention may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, and/or the like, and/or a combination of two or more thereof.

The invention may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

In an embodiment, the invention may be web-based. For example, a server may operate a web application to allow the invention to operate in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™, Firefox™ Chrome™, Safari™ or the like) may render the application executable. A web-based service may be more beneficial due to the ubiquity of web browsers and the convenience of using a web browser as a client (i.e., thin client). Further, with inherent support for cross-platform compatibility, the web application may be maintained and updated without distributing and installing software on each.

Further in accordance with various embodiments of the invention, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

In an embodiment, the invention may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A process for an optimal payment rate calculation of medical diagnostic equipment comprising:
receiving in a processor audit information for each facility using medical diagnostic equipment that includes equipment information that comprises at least a manufactured date of each medical diagnostic device;
storing the equipment information in a database; and
calculating a percentage loss in allowed reimbursement based upon an actual useful life calculation in the processor.

2. The process for optimal payment rate calculation of medical diagnostic equipment according to claim 1 wherein the receiving comprises receiving over a network.

3. The process for optimal payment rate calculation of medical diagnostic equipment according to claim 1 wherein the receiving comprises receiving from an information capturing device.

4. The process for optimal payment rate calculation of medical diagnostic equipment according to claim 1 wherein a percentage loss is zero during the useful life of the medical diagnostic device.

5. The process for optimal payment rate calculation of medical diagnostic equipment according to claim 1 wherein a percentage loss is greater than zero after the useful life of the medical diagnostic device.

6. The process for optimal payment of rate calculation of medical diagnostic equipment according to claim 1 wherein calculating a percentage loss comprises calculating a percentage loss that discretely increases after the useful life of the medical diagnostic device.

7. The process for optimal payment of rate calculation of medical diagnostic equipment according to claim 1 wherein calculating a percentage loss comprises calculating a percentage loss that continuously increases after the useful life of the medical diagnostic device.

8. A system for an optimal payment rate calculation of medical diagnostic equipment comprising:
a processor configured to receive audit information for each facility using medical diagnostic equipment that includes equipment information that comprises at least a manufactured date of each medical diagnostic device;
a database configured to store the equipment information; and
the processor further configured to calculate a percentage loss in allowed reimbursement based upon an actual useful life calculation.

9. The system for optimal payment rate calculation of medical diagnostic equipment according to claim 8 wherein the processor is further configured to receive information over a network.

10. The system for optimal payment rate calculation of medical diagnostic equipment according to claim 8 wherein the processor is further configured to receive information from an information capturing device.

11. The system for optimal payment rate calculation of medical diagnostic equipment according to claim 8 wherein a percentage loss is zero during the useful life of the medical diagnostic device.

12. The system for optimal payment rate calculation of medical diagnostic equipment according to claim 8 wherein a percentage loss is greater than zero after the useful life of the medical diagnostic device.

13. The system for optimal payment of rate calculation of medical diagnostic equipment according to claim 8 wherein calculating a percentage loss comprises calculating a percentage loss that discretely increases after the useful life of the medical diagnostic device.

14. The system for optimal payment of me rate calculation of medical diagnostic equipment according to claim 8 wherein calculating a percentage loss comprises calculating a percentage loss that continuously increases after the useful life of the medical diagnostic device.

15. A system for an optimal payment rate calculation of medical diagnostic equipment comprising:
means for receiving audit information for each facility using medical diagnostic equipment that includes equipment information that comprises at least a manufactured date of each medical diagnostic device;
means for storing the equipment information; and
means for calculating a percentage loss in allowed reimbursement based upon an actual useful life calculation.

16. The system for optimal payment rate calculation of medical diagnostic equipment according to claim 15 wherein the means for receiving comprises receiving over a network.

17. The system for optimal payment rate calculation of medical diagnostic equipment according to claim 15 wherein the means for receiving comprises means for receiving from an information capturing device.

18. The system for optimal payment rate calculation of medical diagnostic equipment according to claim 15 wherein a percentage loss is zero during the useful life of the medical diagnostic device.

19. The system for optimal payment rate calculation of medical diagnostic equipment according to claim 15 wherein a percentage loss is greater than zero after the useful life of the medical diagnostic device.

20. The system for optimal payment of rate calculation of medical diagnostic equipment according to claim 15 wherein calculating a percentage loss comprises calculating a percentage loss that one of discretely and continuously increases after the useful life of the medical diagnostic device.
